(19) United States
(12) Patent Application Publication
(10) Pub. No.: US 2008/0316526 A1
(43) Pub. Date: Dec. 25, 2008

(54) IMAGE FORMING APPARATUS AND SETUP METHOD IN IMAGE FORMING APPARATUS

(75) Inventors: Eiji MATSUZAKI, Matsumoto-shi (JP); Hikonosuke UWAI, Azumino-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/020,405

(22) Filed: Jan. 25, 2008

(30) Foreign Application Priority Data
Jan. 25, 2007 (JP) 2007-014527

(51) Int. Cl. G06F 3/12

(52) U.S. Cl. 358/1.15

(57) ABSTRACT

In order to provide an image forming apparatus through which the user can perform a print out under which a desirably printed out image is laid out on a desired record sheet, the image forming apparatus according to the present invention includes an operation panel unit which displays an input data preview window that displays input data which is input from an external device or input data which is read out by a manuscript readout mechanism, an output sheet size selection window that selects an output sheet size, an output application setup selection window that selects an output application setup, an output figuration preview window that displays an output figuration which is determined based on an output sheet size which is selected by the output sheet size selection window and an output application setup which is selected by the output application setup selection window, an input data adjustment window that adjusts input data, and an output result preview window that displays input data which is adjusted by the input data adjustment window and the output figuration.

### CROSS REFERENCE TO RELATED APPLICATIONS

The present invention contains subject matter related to Japanese Patent Application JP2007-14527 filed in the Japanese Patent Office on Jan. 25, 2007, the entire contents, or specification, drawings, and abstract of which being incorporated herein by reference.

### BACKGROUND OF THE INVENTION

1. Field of the Invention

This invention relates to an image forming apparatus that displays input data on a display apparatus such as an operation panel using a preview in advance and then actually prints out the input data, and a setup method in the image forming apparatus.

2. Description of the Related Art

There is an image forming apparatus called a digital multi-function device (simply referred to as multi-function device, hereinafter) having a scanner and a printer. This multi-function device is provided with the scanner function of taking in an image using a scanner, printing function of printing out data using a printer, copying function of printing out an image read out by a scanner using a printer, and FAX function of transmitting/receiving a FAX document using a FAX unit. Furthermore, in addition to the multi-function device, an image forming apparatus such as a copying machine which is provided with only the copying function is widely used.

As the above-described image forming apparatus, there is known one which is provided with the preview function under which image data which is input from an external device or image data which is read out by a scanner mechanism is displayed, and printing is performed. For example, in a Patent Document 1 (JP-A-2004-282439), there is disclosed an image forming apparatus that displays a read out manuscript or a virtual manuscript in a preview screen as a preview image, and performs a simple editing for an image and a setup for post-processing on the preview image using a touch panel or a mouse by reflecting the processing to the preview image, and printing or post-processing can be performed so that an image displayed on the preview image can be obtained.

### SUMMARY OF THE INVENTION

In the image forming apparatus disclosed in the JP-A-2004-282439, while a simple editing can be performed for the preview image in the preview screen, and a setup for post-processing can be performed, how the printing is performed when the preview image is printed out on an output sheet cannot be set up. In general, in an image forming apparatus, record sheets of various sizes and directions are set, and the user arbitrarily selects the size and direction of the record sheets to perform the printing. On the other hand, in the image forming apparatus disclosed in the Patent Document 1, how the size and direction of an actual record sheet is made to correspond to the preview image cannot be setup, and there is a problem that the user cannot see how a printed out image is laid out on a record sheet before the user see the actual printing result.

In view of the above-identified circumstances, according to the present invention, there is provided an image forming apparatus that includes an operation panel unit which displays: an input data preview window that displays input data; an output figuration preview window that displays an output figuration which is determined based on a setup related to a selection of an output sheet size and an application setup related to an output; and an output result preview window that adjusts the display of input data of the input data preview window such that the display corresponds with the output figuration, and relates the adjusted display with the display of an output figuration on the output figuration preview window, and displays the result.

According to the image forming apparatus, the setup related to a selection of an output sheet size in the output figuration preview window is performed by an output sheet size selection window that selects an output sheet size.

According to the image forming apparatus, the application setup related to an output in the output figuration preview window is performed by an output application setup selection window that selects an output application setup.

According to the image forming apparatus, the setup of adjusting the display of input data of the input data preview window such that the display corresponds with the output figuration is performed by an input data adjustment window which has been prepared in advance.

According to the image forming apparatus, the display on the output result preview window is carried out by performing the drag and drop with respect to input data displayed on the input data preview window to the output figuration preview window.

According to the image forming apparatus, input data which is input from the external device is any one of data transmitted from a personal computer, FAX document data which the image forming apparatus itself receives, data transmitted from an external storage device that is directly connected to the image forming apparatus.

According to the image forming apparatus, in the output application setup, a setup of whether or not any one of N in 1, page continuous printing, and poster printing is performed, a setup of whether or not both side printing is performed, a setup for the binding margin position and binding margin width can be performed. According to the image forming apparatus, the adjustment in the input data adjustment window is the change of magnifying power and the change of rotation angle of the input data.

According to the image forming apparatus, in the output result preview window, when input data which is adjusted in the input data adjustment window is not set in the output figuration, a warning representing whether or not the printing is performed is displayed for the user.

According to the present invention, there is also provided a setup method in an image forming apparatus, wherein, on an output figuration preview screen which is determined based on a selected output sheet size and a selected output application setup, input data which is input from an external device or input data which is read out by a document readout mechanism is displayed after changing the magnifying power or changing the rotation angle thereof, and a printing output result is virtually confirmed.

According to the image forming apparatus and setup method in the image forming apparatus of the present invention, using an output result preview window that displays input data which is adjusted by an input data adjustment window and output figuration, it becomes possible to confirm the size and direction of an actual record sheet and a preview of an image to be printed out. Accordingly, the user can perform a print out under which a desirably printed out image is laid out on a desired record sheet.

### BRIEF DESCRIPTION OF THE DRAWINGS

FIG. 1 shows a block diagram indicative of the system configuration of an image forming apparatus (multi-function device) and the periphery thereof according to an embodiment of the present invention;

FIG. 2 shows a schematic view indicative of a display example of an operation panel 500 of the image forming apparatus (multi-function device) according to the embodiment of the present invention;

FIG. 3 shows a schematic view to explain the user operation on the operation panel 500 of the image forming apparatus (multi-function device) according to the embodiment of the present invention;

FIG. 4 shows a schematic view to explain the user operation on the operation panel 500 of the image forming apparatus (multi-function device) according to the embodiment of the present invention;

FIG. 5 shows a schematic view to explain the user operation on the operation panel 500 of the image forming apparatus (multi-function device) according to the embodiment of the present invention;

FIG. 6 shows a schematic view to explain the user operation on the operation panel 500 of the image forming apparatus (multi-function device) according to the embodiment of the present invention;

FIG. 7 shows a schematic view to explain the user operation on the operation panel 500 of the image forming apparatus (multi-function device) according to the embodiment of the present invention;

FIG. 8 shows a schematic view to explain the user operation on the operation panel 500 of the image forming apparatus (multi-function device) according to the embodiment of the present invention;

FIG. 9 shows a schematic view to explain the user operation on the operation panel 500 of the image forming apparatus (multi-function device) according to the embodiment of the present invention;

FIG. 10 shows a schematic view to explain the user operation on the operation panel 500 of the image forming apparatus (multi-function device) according to the embodiment of the present invention;

FIG. 11 shows a schematic view to explain the user operation on the operation panel 500 of the image forming apparatus (multi-function device) according to the embodiment of the present invention;

FIG. 12 shows a schematic view indicative of a display example of the operation panel 500 of the image forming apparatus (multi-function device) according to the embodiment of the present invention; and

FIG. 13 shows a schematic view indicative of a display example of the operation panel 500 of the image forming apparatus (multi-function device) according to another embodiment of the present invention.

### DETAILED DESCRIPTION OF THE PREFERRED EMBODIMENTS

Now, embodiments of the present invention will be described by referring to the accompanying drawings. In this embodiment, as an image forming apparatus, an explanation will be made by taking a multi-function device for example, to which the present invention is not restricted, and the present invention can be applied to an image forming apparatus as a simple-body copying machine or an image forming apparatus such as a dedicated facsimile machine.

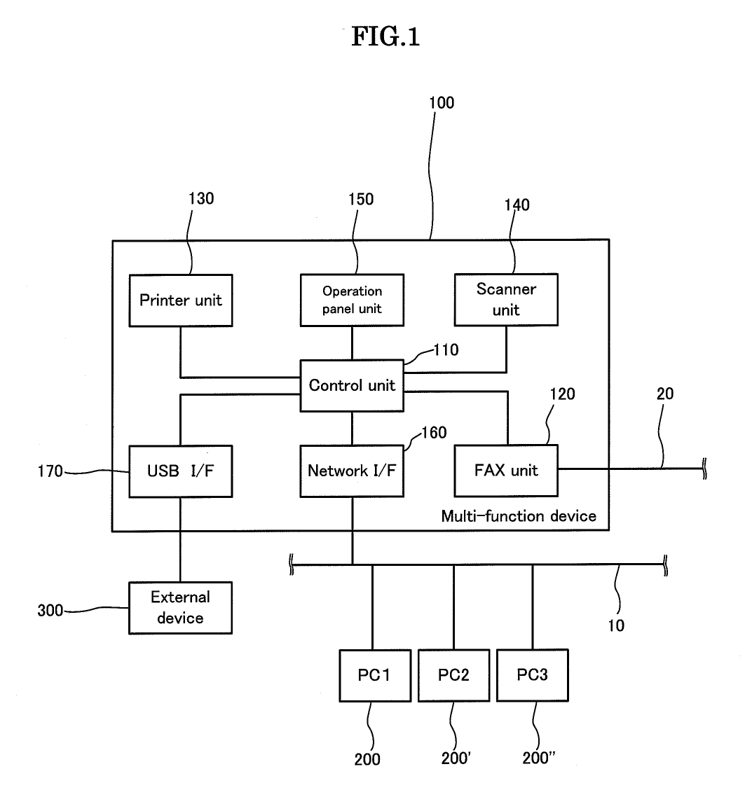

FIG. 1 shows a block diagram indicative of the system configuration of an image forming apparatus (multi-function device) and the periphery thereof according to the embodiment of the present invention. In FIG. 1, a reference numeral “10” represents a network such as a LAN, a WAN, a reference numeral “20” represents a telephone line, a reference numeral “100” represents a multi-function device, a reference numeral “110” represents a control unit that mainly controls the multi-function device, a reference numeral “120” represents a FAX unit that transmits/receives a FAX document, a reference numeral “130” represents a printer unit that prints out data to a recording medium, a reference numeral “140” represents a scanner unit that reads out a document, a reference numeral “150” represents an operation panel unit that functions as an interface with the user, a reference numeral “160” represents a network I/F, a reference numeral “170” represents a USB I/F, reference numerals “200”, “200”, “200′” represent personal computers, and a reference numeral “300” represents an external device, respectively.

In the system around the image forming apparatus shown in FIG. 1, the personal computers 200, 200′, 200″ such as clients and the multi-function device 100 are connected through the network 10. Furthermore, the FAX unit 120 of the multi-function device 100 is connected to the telephone line 20, and the USB I/F 170 is connected to the external device 300 such as a cellular phone and a digital camera.

The multi-function device 100 includes the control unit 110 that mainly controls the multi-function device main body configuring an information processing apparatus, operation panel unit 150 configuring an input-output apparatus that accepts an input operation of the user, scanner unit 140 that scans and reads in a manuscript and an image, printer unit 130 that prints out data to a printing sheet etc., and FAX unit 120 that performs FAX transmission/reception. That is, the multi-function device 100 is provided with the scanner function, printing function, copying function which combines the scanner function and printing function, and FAX transmission/reception function.

The information processing mechanisms of the multi-function device 100 are configured by, for example, a general-purpose computer system respectively, and individual configuration components or functions are realized by, for example, executing a computer program written in a storage means.

The scanner unit 140 has a manuscript board, not shown, on which a manuscript can be placed, and an optical system that reads out the manuscript. On the manuscript board of the scanner unit 140, a manuscript size detection sensor that can detect the size of a manuscript placed on the manuscript board is arranged. Furthermore, in the multi-function device 100, an ADF (Automatic Document Feeder) that automatically and consecutively feeds manuscripts to the scanner unit 140 may be arranged.

Data which is read out by the scanner unit 140 is stored once in a storage means, not shown, of the control unit 110. In accordance with a designation from the operation panel unit 150, the control unit 110 outputs manuscript image data read out by the scanner unit 140 on a paper from the printer unit 130 directly or under a set up magnifying power (copying function of the multi-function device 100), or transmits the manuscript image data from the FAX unit 120 through a telephone line (FAX function of the multi-function device 100), or transmits the manuscript image data to the personal computers 200, 200′, 200″ through the network I/F 160 and network 10 (scanner function of the multi-function device 100).

The printer unit 130 forms an image on a record sheet, and can use the widely known hardware configuration such as the electrophotographic manner employing a method of forming a latent image on a photo conductor using a laser and a LED line head, or the ink-jet manner employing a method of directly shooting out ink to a record sheet. The control unit 110 makes the printer unit 130 output a predetermined paper based on a designation from the operation panel unit 150, personal computers 200, 200′, 200″, or external device 300 such as a cellular phone and a digital camera. That is, the printer unit 130 outputs image data read out by the scanner unit 140, FAX data received by the FAX unit 120, data from application software of the personal computers 200, 200′, 200″, or image data from the external device 300 on a paper.

The FAX unit 120 is connected to the telephone line 20, and has a FAX transmission/reception unit, not shown, that transmits/receives data by FAX, and a FAX unit memory that configures a transmission buffer that temporarily stores transmission data to be transmitted by the FAX transmission/reception unit as well as a reception buffer that temporarily stores reception data received by the FAX transmission/reception unit.

When receiving image data read out by the scanner unit 140 from the control unit 110, the FAX unit 120 stores the image data in a FAX memory unit 121 once, and transmits the image data by FAX. When the transmission is completed, the FAX unit 120 deletes the transmitted image data which is stored in the FAX memory unit 121. Furthermore, when receiving data which is transmitted by FAX from the telephone line 20, the FAX unit 120 stores the received data therein once. Then, thus stored received data is sent to the control unit 110, and is then sent to the printer unit 130 to be printed out. The FAX unit 120 performs FAX transmission/reception independently of other components in the multi-function device 100. That is, when accepting transmission data from the multi-function device 100, the FAX unit 120 transmits the transmission data by FAX independently of the multi-function device 100, and, when FAX data is transmitted through the telephone line 20, the FAX unit 120 receives the FAX data.

The copying function of the multi-function device 100 is set up in the control unit 110 by the operation for the operation panel unit 150 by the user. From the operation panel unit 150, setting up copy magnifying power, setting up manuscript image size, setting up size of output sheet related to the copying function can be performed, and the control unit 110 executes the copying function of the multi-function device 100 based on the setting up. The copying function of the multi-function device 100 performs copy magnifying power processing for manuscript image data of a manuscript read out by the scanner unit 140, and outputs the manuscript image data on a paper using a sheet whose size is specified by the printer unit 130.

The hardware of the operation panel unit 150 is configured substantially by a display unit being an LCD that performs displaying processing related to the operation, and a touch panel unit that can accept input when the touch panel unit is pressed by a finger etc. These display unit and touch panel unit are overlapped, and referring to the display of the display unit, the user can perform various setups of the multi-function device 100 by operating the touch panel unit using a finger. As specific configurations of the input mechanism by the touch panel unit and the display mechanism by the display unit, the well-known technique disclosed in the Patent Document 1 can be used. The operation panel unit 150 can select various functions such as the FAX function, printer function, and copying function of the multi-function device 100, and perform the preview display of a read out image, preview display of an image which is being processed of a read out image.

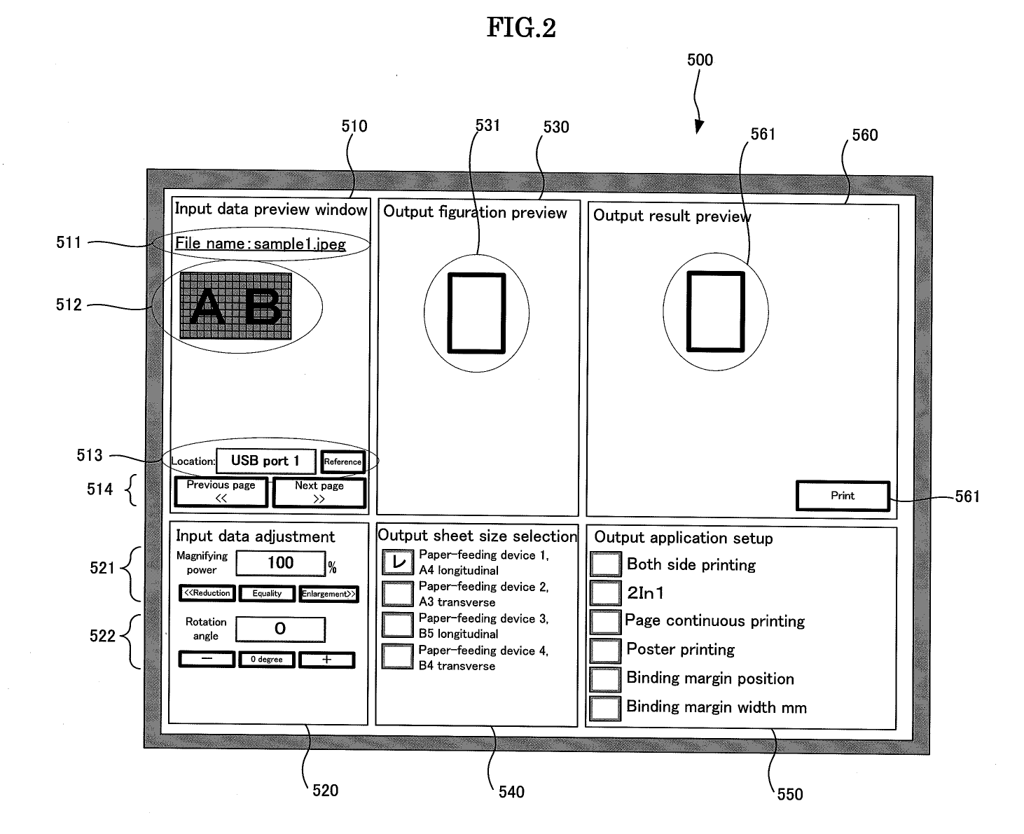

The present invention relates to the preview display of the operation panel unit 150 and the image data processing steps in the preview display of an image forming apparatus such as thus configured the above-described multi-function device 100. FIG. 2 shows a schematic view indicative of a display example of an operation panel 500 of the image forming apparatus (multi-function device) according to the embodiment of the present invention. In FIG. 2, a reference numeral “500” represents the operation panel, a reference numeral “510” represents an input data preview window, a reference numeral “511” represents an input data file name display unit, a reference numeral “512” represents an input data display unit, a reference numeral “513” represents an input data location display selection unit, a reference numeral “514” represents an input data page selection button, a reference numeral “520” represents an input data adjustment window, a reference numeral “521” represents a magnifying power display selection unit, a reference numeral “522” represents a rotation angle display selection unit, a reference numeral “530” represents an output figuration preview window, a reference numeral “531” represents an output figuration preview unit, a reference numeral “540” represents an output sheet size selection window, a reference numeral “550” represents an output application setup selection window, a reference numeral “560” represents an output result preview window, and a reference numeral “561” represents a printing execution button.

The hardware of the operation panel 500 is configured substantially by a display unit being an LCD that performs displaying processing related to the operation, and a touch panel unit that can accept input when the touch panel unit is pressed by a finger etc., and the display of the operation panel 500 is substantially composed of total six window displays or the input data preview window 510, input data adjustment window 520, output figuration preview window 530, output sheet size selection window 540, output application setup selection window 550, and output result preview window 560.

The input data preview window 510 is a window that directly displays information related to input data and input data itself to be printed out in the printer unit 130 by the user with the input data unprocessed. As input data to be printed out in the printer unit 130, there are FAX document data received by the FAX unit 120, manuscript data read out by the scanner unit 140, data transmitted from the personal computers 200, 200′, 200″ to the multi-function device 100, data transmitted from the external device 300 such as a digital camera.

The input data file name display unit 511 in the input data preview window 510 is a part that displays the file name of input data, and the input data display unit 512 is a place that displays the thumbnail of input data itself. Furthermore, the input data location display selection unit 513 can represent an information device (or port to which an information device is connected) where input data exists, and change the information device where input data exists by touching a “reference” button shown in FIG. 2 using a finger. Furthermore, the input data page selection button 514 is composed of a “previous page” button and a “next page” button, and, by touching the respective buttons using a finger, the thumbnail to be displayed on the input data display unit 512 can be set to that of the previous page or that of the next page.

In displaying input data, the input data preview window 510 directly displays input data itself with the input data unprocessed, while the input data adjustment window 520 can determine how the unprocessed input data is to be processed. The input data adjustment window 520 is configured by the magnifying power display selection unit 521 and rotation angle display selection unit 522, and the magnifying power display selection unit 521 changes the magnifying power of input data, and the rotation angle display selection unit 522 changes the rotation angle of input data. The processing of changing the magnifying power and changing the rotation angle of input data is the heretofore known technique in the field of the image forming apparatus, and, as specific processing of changing the magnifying power and changing the rotation angle of input data in the present invention, the heretofore known technique can be used.

As shown in FIG. 2, the magnifying power display selection unit 521 is composed of parts indicative of the magnifying power, or a “reduction” button, an “equality” button, and an “enlargement” button. At a part where the magnifying power is displayed, the magnifying power of input data is displayed, and, by touching the “reduction” button, “equality” button, and “enlargement” button using a finger, input data can be reduced, equalized, and enlarged. Furthermore, the rotation angle display selection unit 522 is composed of parts indicative of the rotation angle, or a “−” button, a “0-degree” button, and a “+” button. At a part where the rotation angle is displayed, the rotation angle of input data is displayed, and, by touching the “−” button, “0-degree” button, and “+” button using a finger, the rotation angle of input data can be changed. It is defined that the rotation angle in the clockwise direction of input data is the positive rotation angle, while the rotation angle in the counterclockwise direction of input data is the negative rotation angle.

The output sheet size selection window 540 is a window that selects a paper-feeding device to be used to print out data in the printer unit 130. As the hardware of the paper-feeding device, mechanism of selecting one paper-feeding device from among plural paper-feeding devices, etc., the heretofore known technique can be used. In general, in the paper-feeding devices, sheets of various sizes and directions are set to be used. For example, in an example of the output sheet size selection window 540 shown in FIG. 2, sheets of A4 longitudinal are set in a paper-feeding device 1, sheets of A3 transverse are set in a paper-feeding device 2, sheets of B5 longitudinal are set in a paper-feeding device 3, and sheets of B4 transverse are set in a paper-feeding device 4. Furthermore, in the example of the output sheet size selection window 540 shown in FIG. 2, the paper-feeding device 1 in which sheets of A4 longitudinal are set is selected. Selection of the paper-feeding device in the output sheet size selection window 540 can be performed by, for example, touching a check box arranged at the left side of the paper-feeding device 1 using a finger. Then, a check mark is displayed on the check box display of the selected paper-feeding device.

The output figuration preview window 530 is a window on which the size and direction of output sheets set in the paper-feeding device 1 which is selected in the output sheet size selection window 540 are displayed, and in the example shown in FIG. 2, sheets of A4 longitudinal, which are set in the paper-feeding device 1, are displayed.

The output application setup selection window 550 is a window that is used when performing application print setup, and, when the application print setup is desired to be performed, the user selects an application setup by touching check boxes arranged at the left side of parts where “both side printing”, “2 in 1”, “page continuous printing”, “poster printing”, “binding margin position”, and “binding margin width mm” are displayed. Then, a check mark is displayed on the check box display of the selected application setup. As application print, when performing the “both side printing”, “2 in 1”, “page continuous printing”, “poster printing”, “binding margin position”, and “binding margin width mm”, the well-known print method can be employed. Among the above-described application print setups, as for the “2 in 1” print, there may be “N in 1” print such as “4 in 1” and “8 in 1”. Furthermore, in the image forming apparatus, setup of whether or not which of the “N in 1”, “page continuous printing”, and “poster printing” is performed, setup of whether or not the “both side printing” is performed, and setup for the “binding margin position” and “binding margin width mm” can be performed in parallel. In case the application print setup is unnecessary, and the user desires to perform the usual printing, the check mark is not displayed on any of the check box displays of the output application setup selection window 550. In order to display no check mark, for example, the user touches part in the output application setup selection window 550 where items of the application setup are not displayed (blank space where no item is displayed) using a finger. In the output application setup selection window 550 shown in FIG. 2, since the check mark is not displayed on any of the check box displays of the output application setup selection window 550, the usual printing is set up.

The output application setup (including usual printing) set up in the output application setup selection window 550 is reflected on the display of the output figuration preview window 530. That is, in the output figuration preview window 530, an output figuration which is determined based on the paper-feeding device (output sheet size) selected in the output sheet size selection window 540, and the output application setup (including usual printing) selected in the output application setup selection window 550 is set to a preview window displayed on the output figuration preview unit 531.

The output result preview window 560 is a window on which input data adjusted in the input data adjustment window 520 and an output figuration displayed on the output figuration preview window 530 are combined (561) to be displayed, and the state displayed on the output result preview window 560 is to be actually printed out from the printer unit 130.

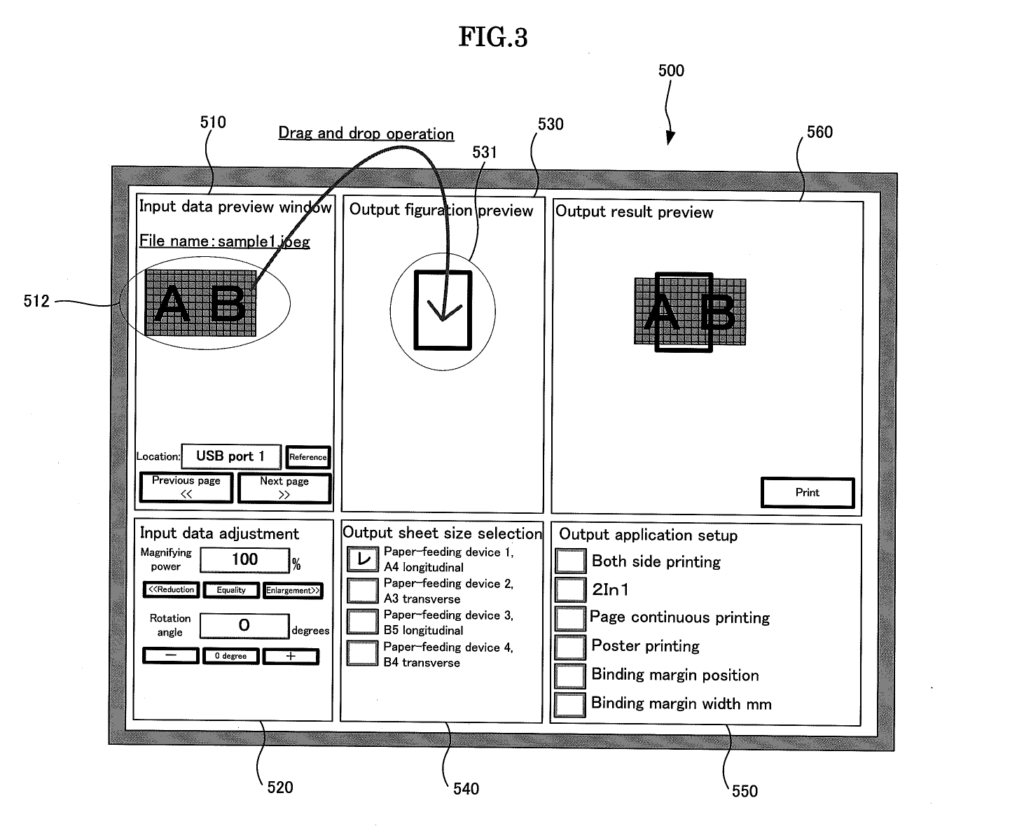

Next, the user operation in thus configured operation panel 500 will be explained. FIG. 3 to FIG. 5 show schematic views to explain the user operation on the operation panel 500 of the image forming apparatus (multi-function device) according to the embodiment of the present invention.

The user operation to print out a file name: sample1. jpeg shown in FIG. 2 will be explained. When input data of the file name: sample1. jpeg is received by the multi-function device 100, in the initial state, the display on the operation panel 500 is set to that shown in FIG. 2. Then, as shown in FIG. 3, the user is prompted to touch the input data display unit 512 of the input data preview window 510 using a finger, and shift the input data display unit 512 with the finger set in contact with the operation panel 500, and set apart the finger therefrom at the output figuration preview unit 531 of the output figuration preview window 530 (this operation is referred to as “drag and drop”, hereinafter). When the drag and drop operation by the user is recognized by the multi-function device 100, the output result preview window 560 of the operation panel 500 displays data which is obtained by combining unprocessed input data (sample1. jpeg) and an output figuration displayed on the output figuration preview window 530 (frame of A4 longitudinal size). In the display of the output result preview window 560 shown in FIG. 3, since the input data (sample1. jpeg) surpasses the frame of A4 longitudinal size being the output figuration, even if the print out is performed by the printer unit 130 under the state, the input data is to be printed out without being set in a sheet.

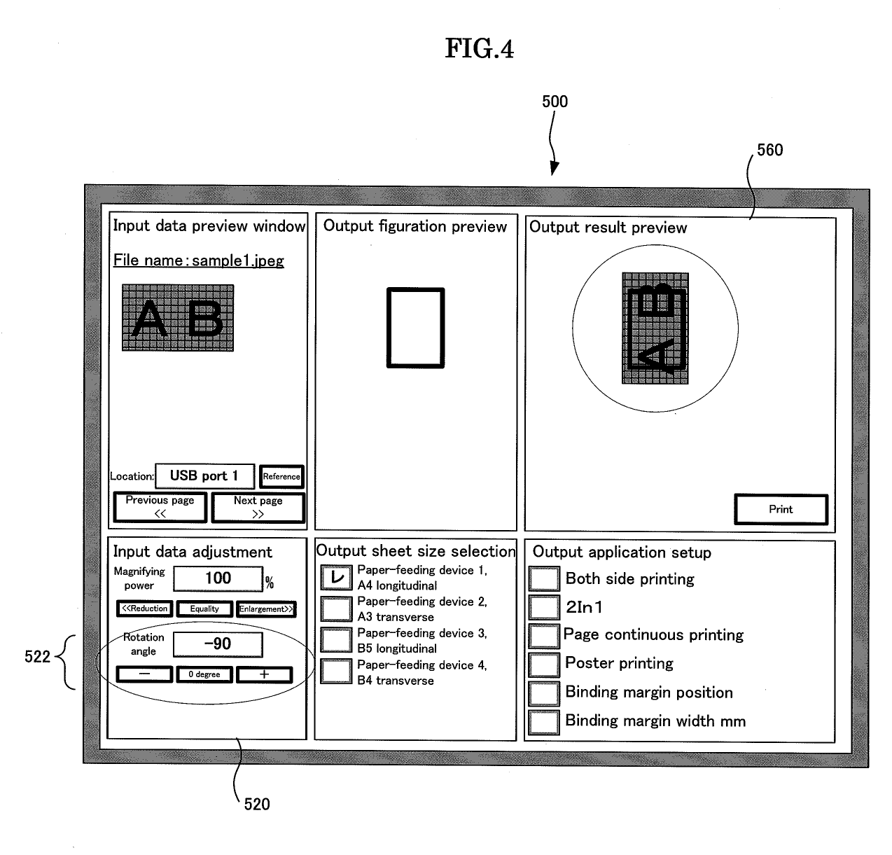

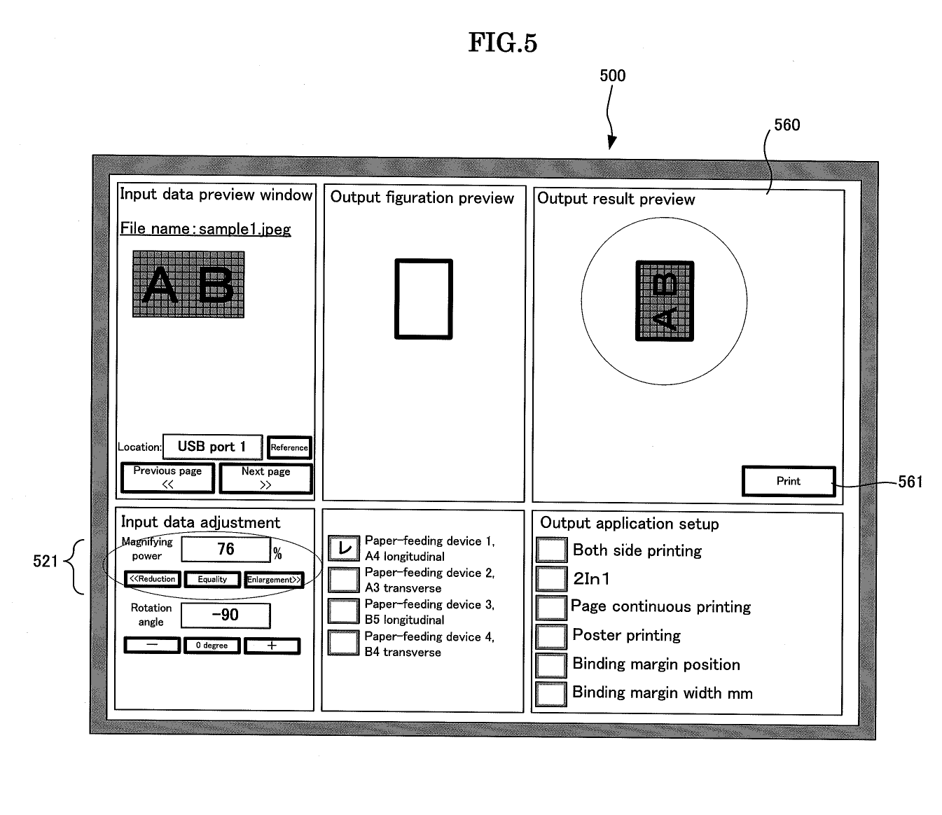

Referring to the display result in the output result preview window 560, the user adjusts the magnifying power and rotation angle of the input data in the input data adjustment window 520. FIG. 4 shows a state in which, since the rotation angle is set to −90 degrees in the input data adjustment window 520, the display of the input data (sample1. jpeg) is rotated by −90 degrees in the output result preview window 560. Furthermore, FIG. 5 shows a state in which, since the magnifying power is set to 76% in the input data adjustment window 520, the display of the input data (sample1. jpeg) is reduced to 76% in the output result preview window 560. By thus adjusting the magnifying power and rotation angle of the input data, the input data (sample1. jpeg) does not surpass the frame of A4 longitudinal size being the output figuration. In this way, referring to the display result in the output result preview window 560, the user adjusts the input data in the input data adjustment window 520, and performs the print out by touching the printing execution button 561 using a finger. Accordingly, it becomes possible to print out an image which does not have its part lacked from the printer unit 130.

In this way, according to the image forming apparatus and setup method in the image forming apparatus of the present invention, using the input data adjusted in the input data adjustment window and the output result preview window which displays an output figuration, the size and direction of an actual record sheet and a preview of an image to be printed out can be confirmed. Accordingly, the user can perform a printout under which a desirably printed out image is laid out on a desired record sheet.

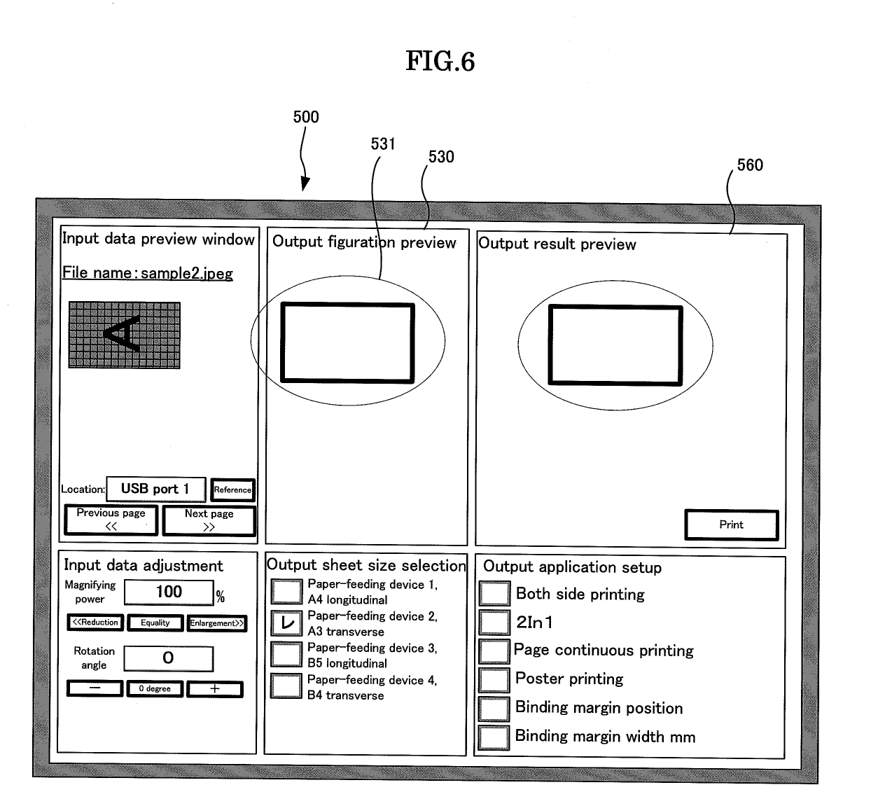

Next, another example of the user operation on the operation panel 500 will be explained. FIG. 6 to FIG. 11 show schematic views to explain the user operation on the operation panel 500 of the image forming apparatus (multi-function device) according to the embodiment of the present invention. In FIG. 6 to FIG. 11, the user operation of a case of printing out file names: sample2. jpeg to sample5. jpeg on a single sheet of A3 transverse will be explained.

When input data of the file name: sample2. jpeg is received by the multi-function device 100, in the initial state, the display on the operation panel 500 is set to that shown in FIG. 6. In this example, in the output sheet size selection window 540, the paper-feeding device 2 in which sheets of A3 transverse are set is selected, and on the output figuration preview window 530 and output result preview window 560, the frame of A3 transverse is displayed.

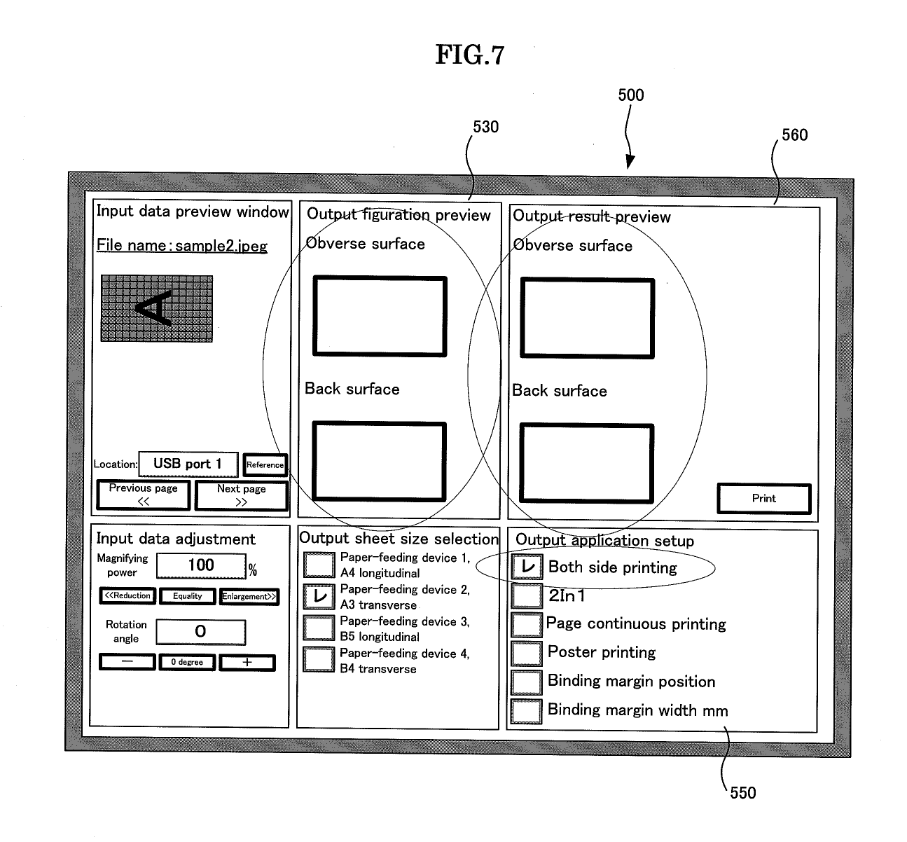

Next, when “both side printing” in the output application setup selection window 550 is selected by the user, the output figuration preview window 530 and output result preview window 560 are set to a state shown in FIG. 7. That is, according to the image forming apparatus and setup method in the image forming apparatus of the present invention, the display method for an output figuration (frame display shown in FIG. 7) in the output figuration preview window 530 is determined based on an output sheet size (paper-feeding device) selected in the output sheet size selection window 540 and an output application setup selected in the output application setup selection window 550. Furthermore, the output figuration of the output figuration preview window 530 is reflected on the output result preview window 560.

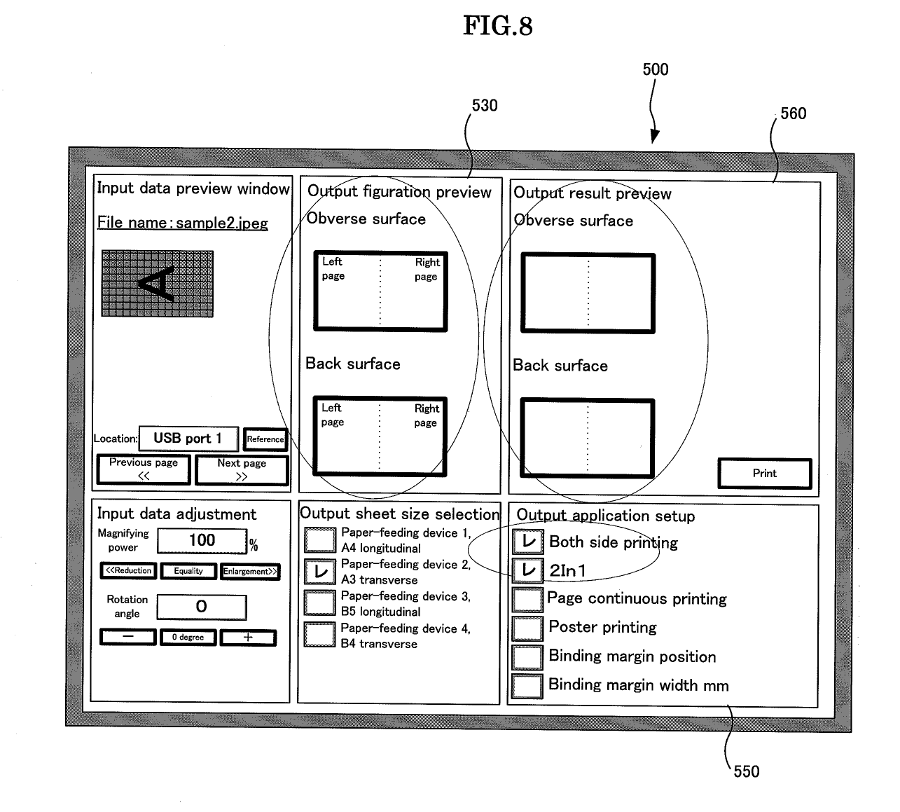

FIG. 8 shows a state in which “2 in 1” is selected in the output application setup selection window 550 by the user. As shown in FIG. 8, according to the present invention, along with the output application setup (“both side printing”, “2 in 1”) selected in the output sheet size selection window 540 and output application setup selection window 550, the output figuration display of the output figuration preview window 530 and output figuration display of the output result preview window 560 are changed.

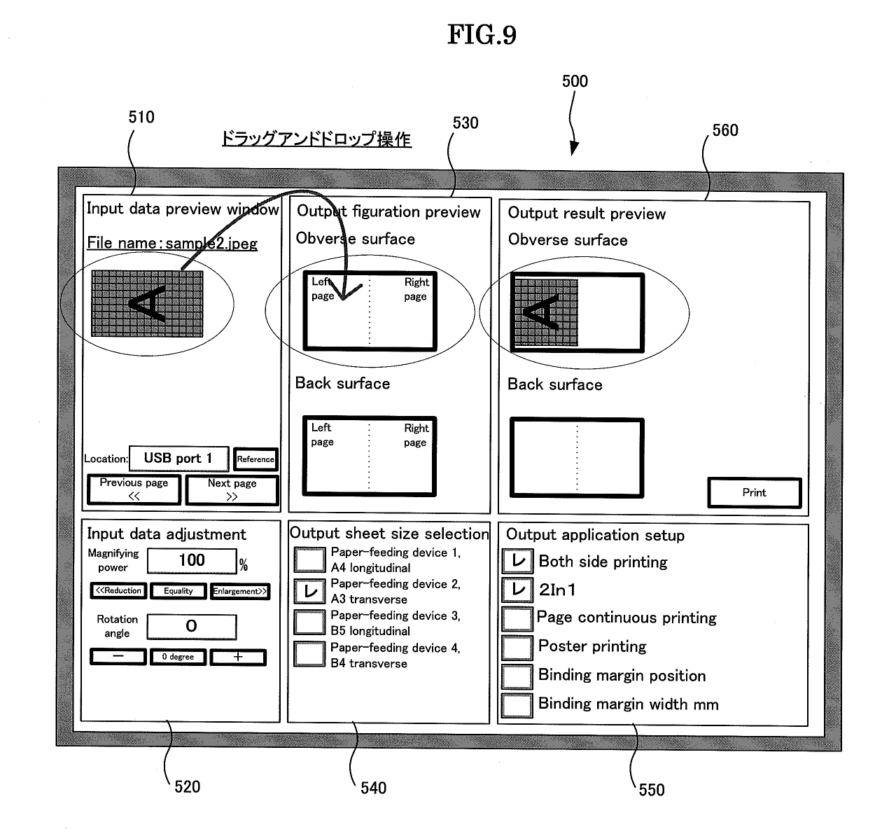

Next, as shown in FIG. 9, when the user performs the drag and drop with respect to the input data (sample2. jpeg) from the input data display unit 512 of the input data preview window 510 to the output figuration preview window 530, on the output result preview window 560, the unprocessed input data (sample2. jpeg) is displayed on the left page part of the obverse surface of the A3 transverse size of the output figuration.

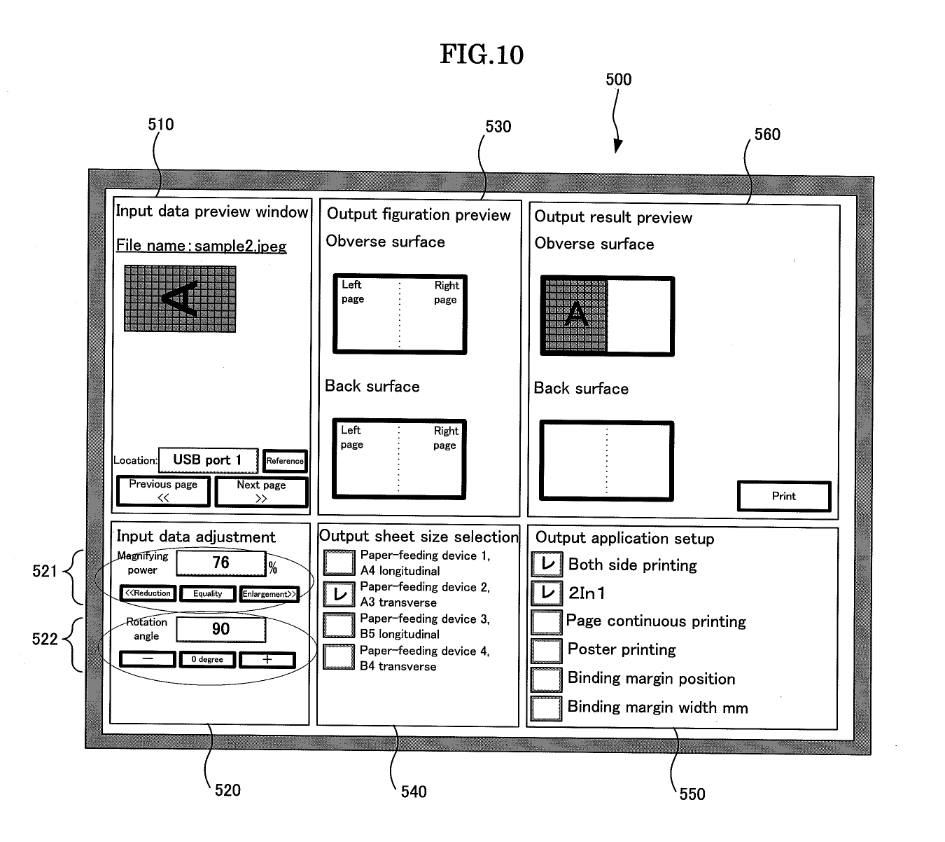

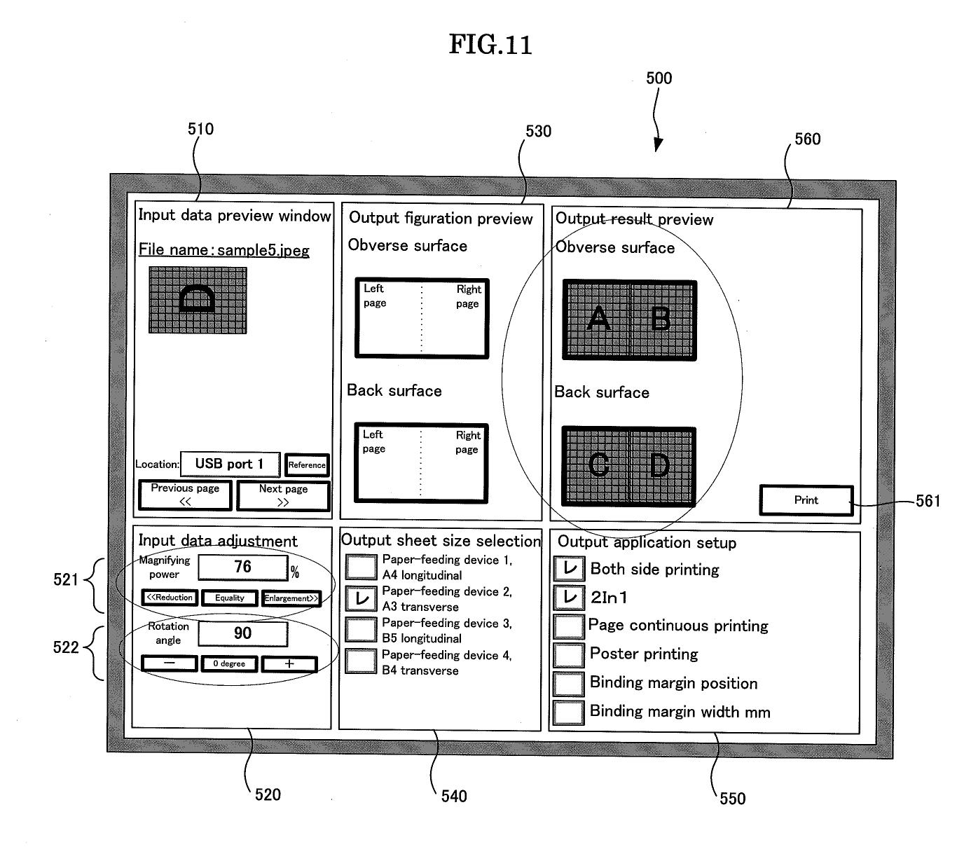

Referring to the display result in the output result preview window 560, the user adjusts the magnifying power and rotation angle of the input data in the input data adjustment window 520. FIG. 10 shows a state in which, in the input data adjustment window 520, the magnifying power is set to 76%, and the rotation angle is set to 90 degrees. Due to the adjustment in the input data adjustment window 520, the display of the left page part of the obverse surface of the A3 transverse size of the output figuration of the output result preview window 560 is set to that shown in FIG. 10, and the input data (sample2. jpeg) does not surpass the frame of the output figuration. As for the input data of sample3. jpeg to sample5. jpeg, by performing the same operation, the user can display the output result preview window 560 shown in FIG. 11. In this way, referring to the display result in the output result preview window 560, the user adjusts input data in the input data adjustment window 520, and executes the print out by touching the printing execution button 561 using a finger. Accordingly, it becomes possible to obtain an image output for which application print setup of “both side printing” and “2 in 1” is performed and which does not have its part lacked from the printer unit 130.

In this way, according to the image forming apparatus and setup method in the image forming apparatus of the present invention, using the input data adjusted in the input data adjustment window and the output result preview window which displays an output figuration, the size and direction of an actual record sheet and the preview of an image to be printed out can be confirmed. Accordingly, the user can perform a print out under which a desirably printed out image is laid out on a desired record sheet.

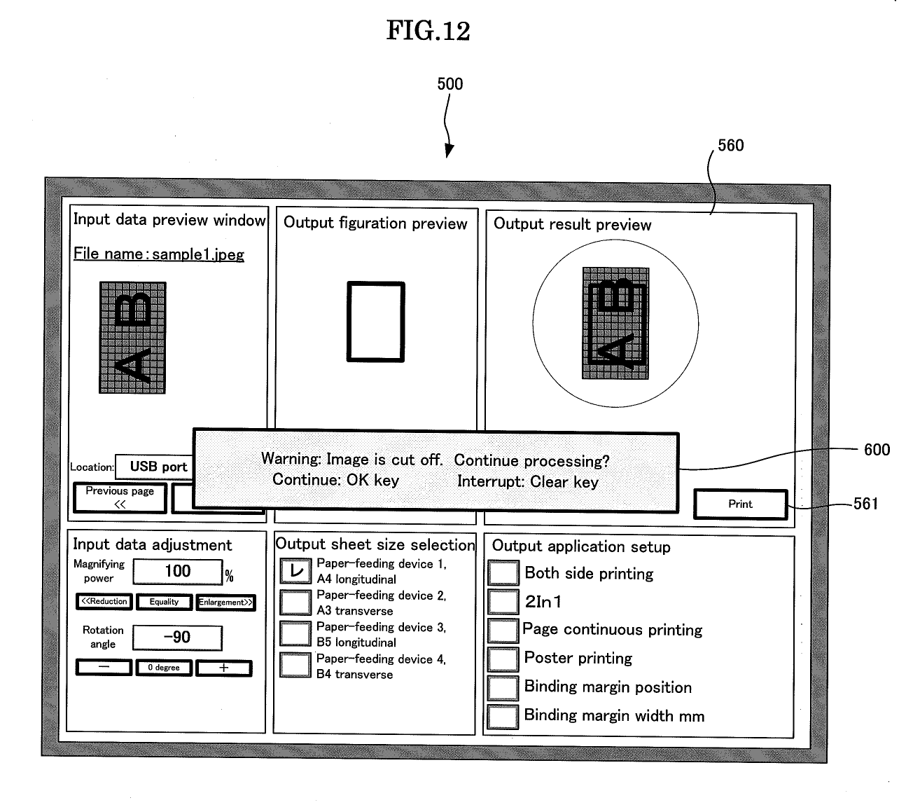

Next, the warning display to the user according to the present invention will be explained. FIG. 12 shows a schematic view indicative of a display example of the operation panel 500 of the image forming apparatus (multi-function device) according to the embodiment of the present invention. As shown in FIG. 12, in the display result of the output result preview window 560, in a state in which the input data (sample1. jpeg) surpasses the output figuration (frame of A4 longitudinal size), when the user touches the printing execution button 561 using a finger, the control unit 110 determines that printing an image which does not have its part lacked cannot be performed in the printer unit 130, and displays a warning display window 600 representing “Image is cut off. Continue processing?” shown in FIG. 12 on the operation panel 500. Using the warning display window 600, useless printing output which is not desired by the user can be prevented.

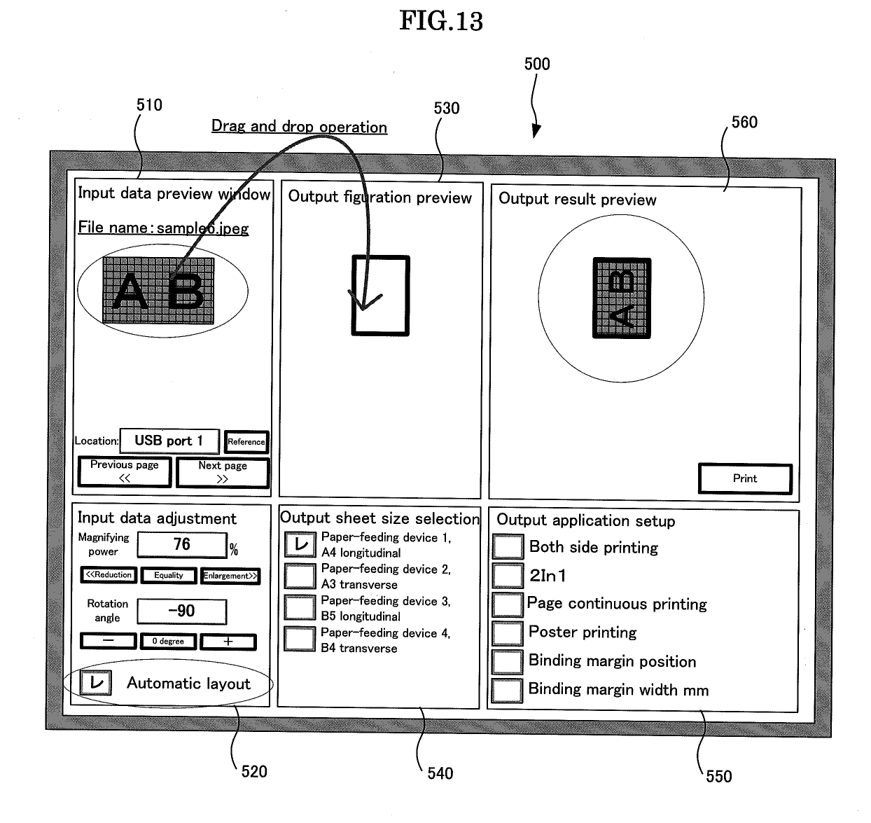

Next, another embodiment of the present invention will be explained. FIG. 13 shows a schematic view indicative of a display example of the operation panel 500 of the image forming apparatus (multi-function device) according to the another embodiment of the present invention. In the input data adjustment window 520 of the image forming apparatus (multi-function device) according to the another embodiment of the present invention, an automatic layout mode is arranged, and, when the automatic layout mode is selected, automatic adjustment (magnifying power change adjustment, rotation angle change adjustment) for input data is performed along with the output figuration. The automatic adjustment technique is widely known in the field of the image forming apparatus, and the present invention can employ the well-known automatic adjustment technique. In order to set the automatic layout mode, a check mark is made to appear in a check box located at the left side of the “Automatic layout” by touching the check box using a finger.

When the automatic layout mode is set up, in order to print out a file name: sample1. jpeg shown in FIG. 13, when the user performs the drag and drop with respect to input data from the input data preview window 510 to the output figuration preview window 530, the magnifying power change adjustment and rotation angle change adjustment for the input data are automatically performed. As a result, with respect to the display of the input data (sample1. jpeg) in the output result preview window 560, the rotation angle is set to be rotated by −90 degrees, and the magnifying power is set to be reduced to 76%. In this way, the user confirms the display result in the output result preview window 560, and executes the print out by touching the printing execution button 561 using a finger. Accordingly, it becomes possible to print out an image which does not have its part lacked from the printer unit 130. As has been described above, also according to the image forming apparatus and setup method in the image forming apparatus of the another embodiment, the user can perform a print out under which a desirably printed out image is laid out on a desired record sheet.

What is claimed is:

1. An image forming apparatus that comprises an operation panel unit which displays:
an input data preview window that displays input data;
an output figuration preview window that displays an output figuration which is determined based on a setup related to a selection of an output sheet size and an application setup related to an output;
an output result preview window that adjusts the display of input data of the input data preview window such that the display corresponds with the output figuration, and relates the adjusted display with the display of an output figuration on the output figuration preview window, and displays the result.

2. The image forming apparatus according to claim 1, wherein
the setup related to a selection of an output sheet size in the output figuration preview window is performed by an output sheet size selection window that selects an output sheet size.

3. The image forming apparatus according to claim 1, wherein
the application setup related to an output in the output figuration preview window is performed by an output application setup selection window that selects an output application setup.

4. The image forming apparatus according to claim 1, wherein
the setup of adjusting the display of input data of the input data preview window such that the display corresponds with the output figuration is performed by an input data adjustment window which has been prepared in advance.

5. The image forming apparatus according to claim 1, wherein
the display on the output result preview window is carried out by performing the drag and drop with respect to input data displayed on the input data preview window to the output figuration preview window.

6. The image forming apparatus according to claim 1, wherein
input data which is input from the external device is any one of data transmitted from a personal computer, FAX document data which the image forming apparatus itself receives, data transmitted from an external storage device that is directly connected to the image forming apparatus.

7. The image forming apparatus according to claim 1, wherein
in the output application setup, a setup of whether or not any one of N in 1, page continuous printing, and poster printing is performed, a setup of whether or not both side printing is performed, a setup for the binding margin position and binding margin width can be performed.

8. The image forming apparatus according to claim 4, wherein
the adjustment in the input data adjustment window is the change of magnifying power and the change of rotation angle of the input data.

9. The image forming apparatus according to claim 1, wherein
in the output result preview window, when input data which is adjusted in the input data adjustment window is not set in the output figuration, a warning representing whether or not the printing is performed is displayed for the user.

10. A setup method in an image forming apparatus, wherein, on an output figuration preview screen which is determined based on a selected output sheet size and a selected output application setup, input data which is input from an external device or input data which is read out by a document readout mechanism is displayed after changing the magnifying power or changing the rotation angle thereof, and a printing output result is virtually confirmed.
